(19) United States
(12) Patent Application Publication
(10) Pub. No.: US 2024/0259974 A1
(43) Pub. Date: Aug. 1, 2024

(54) METHOD AND SYSTEM FOR TIMING ADVANCE ENHANCEMENT FOR MULTI-TRANSMISSION AND RECEPTION POINT TRANSMISSION

(71) Applicant: Samsung Electronics Co., Ltd., Gyeonggi-do (KR)

(72) Inventors: Hoda SHAHMOHAMMADIAN, San Diego, CA (US); Jung Hyun BAE, San Diego, CA (US); Mohamed AWADIN, San Diego, CA (US)

(21) Appl. No.: 18/535,556

(22) Filed: Dec. 11, 2023

Related U.S. Application Data
(60) Provisional application No. 63/441,953, filed on Jan. 30, 2023.
(60) Provisional application No. 63/583,375, filed on Sep. 18, 2023.

(51) Int. Cl. H04W 56/00; H04B 7/024; H04W 74/00; H04W 74/0833

(52) U.S. Cl. CPC H04W 56/0045; H04B 7/024; H04W 74/006; H04W 74/0833

(57) ABSTRACT

A system and a method are provided in which a user equipment (UE) acquires, from a base station (BS), a first timing advance (TA) value for a first transmission and reception point (TRP) and a second TA value for a second TRP via random access channel (RACH) signaling based on an identifier. The UE manages the first TA value and the second TA value during multi-TRP transmission within a cell having the first TRP and the second TRP.

### CROSS-REFERENCE TO RELATED APPLICATION

This application claims the priority benefit under 35 U.S.C. § 119(c) of U.S. Provisional Application Nos. 63/441,953 and 63/583,375, filed on Jan. 30, 2023 and Sep. 18, 2023, respectively, the disclosures of which are incorporated by reference in their entirety as if fully set forth herein.

### TECHNICAL FIELD

The disclosure generally relates to timing advance (TA) mechanisms for uplink (UL) transmissions. More particularly, the subject matter disclosed herein relates to improvements to acquisition and maintenance of multiple TAs in multi-transmission and reception point (M-TRP) transmissions.

### SUMMARY

In new radio (NR), UL transmissions may be synchronized at a base station (BS) (or gNode B (gNB)) antenna interface in order to maintain orthogonality between UL users in a single cell. A TA mechanism ensures timing alignment within one cyclic prefix (CP) at the gNB for UL signals arriving from different user equipments (UEs) in the cell.

Sounding reference signals (SRS) may be used to measure a TA, which may be a negative offset between the start of a downlink slot observed by a UE and the start of an UL slot that compensates for propagation delay. Random access channel (RACH) procedures may be higher-layer triggered (either by the UE or the gNB) as contention-based random access (CBRA) or contention-frec random access (CFRA). A physical downlink control channel (PDCCH) order (e.g., a special form of downlink control information (DCI) 1A) is a network-triggered mechanism in which the network forces the UE to initiate a contention-free or a contention-based RACH transmission.

In such RACH procedures, the UE may send a RACH preamble to the gNB, and the gNB may calculate an initial TA value and provide that value in a corresponding random access response (RAR) to the UE. A TA command (TAC) may be provided to the UE in RAR and/or in medium access control (MAC)-control element (CE) signaling.

The UE may be configured with a group of serving cells. A TA group (TAG) may support non-collocated cell deployments, and is used to extend a group of cells associated with the same TAG to share a same TA. Each TAG is associated with a timeAlignmentTimer. When the timeAlignmentTimer expires, the UE may initiate RACH transmission.

TA may be calculated by (N_{TA}+N_{TA,offset})Tc, where N_{TA} is a UE-maintained TA value according to a TAC in the RAR and/or MAC-CE signaling, and N_{TA,offset} is an overall TA offset. N_{TA,offset} may be configured with n-TimingAdvanceOffset for each serving cell. If the UE is not configured with n-TimingAdvanceOffset, a default value may be determined based on a duplex mode of the cell.

Maintaining a single TA for a cell that is shared by two TRPs may cause timing asynchronization on one TRP due to imperfect time synchronization, and also due to different distances, line-of-sight (LOS)/non-LOS (NLOS) conditions, and different propagation delays from the two TRPs to a given UE.

To solve this problem, for maintenance of two TAs, two downlink (DL) reference timings may be supported, with each DL reference timing associated with a different TAG. A receive (Rx) timing difference between these two DL reference timings may be assumed to be no larger than the CP length. Two n-TimingAdvanceOffset values per serving cell may also be supported, because the two TRPs may be configured with different duplex modes, and hence, two different N_{TA,offset} may be required for the UE for UL M-TRP transmission.

One issue with the above approach is that, for M-TRP, the UE needs to obtain an initial TA value of each TRP and maintain the two TAs. The initial TA acquisition mechanism may be based on a UE-initiated RACH preamble transmission. However, the UE may not be able to determine which of the TRPs is associated with the initial TA value in the RAR.

To overcome these issues, systems and methods are described herein for acquisition and maintenance of two different TA values in M-TRP transmission, an association of two configured TAGs with different TRPs, and handling UL overlapping in time domain multiplexing (TDM)-based M-TRP transmission with two TAs.

In an embodiment, a method includes acquiring, by a UE, from a BS, a first TA value for a first TRP and a second TA value for a second TRP via RACH signaling based on an identifier, and managing the first TA value and the second TA value during M-TRP transmission within a cell having the first TRP and the second TRP.

In an embodiment, a method includes providing, to a UE, from a BS, a first TA value for a first TRP and a second TA value for a second TRP via RACH signaling based on an identifier, and managing, by the BS, the first TA value and the second TA value at the UE during M-TRP transmission within a cell having the first TRP and the second TRP.

In an embodiment, a UE includes a processor and a non-transitory computer readable storage medium storing instructions. When executed, the instructions cause the processor to acquire, from a BS, a first TA value for a first TRP and a second TA value for a second TRP via RACH signaling based on an identifier, and manage the first TA value and the second TA value during M-TRP transmission within a cell having the first TRP and the second TRP.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating an M-TRP transmission scheme, according to an embodiment;

FIG. 2 is a diagram illustrating network-initiated contention-based RACH transmissions for acquisition of a second TA, according to an embodiment;

FIG. 3 is a diagram illustrating an RAR, according to an embodiment;

FIG. 4 is a diagram illustrating network-initiated contention-free RACH transmissions for acquisition of a second TA, according to an embodiment;

FIG. 5 is a diagram illustrating UE-initiated contention-based RACH transmissions for acquisition of a second TA, according to an embodiment;

FIG. 6 is a diagram illustrating UE-initiated contention-free RACH transmissions for acquisition of a second TA, according to an embodiment;

FIG. 7 is a diagram illustrating UE-initiated contention-based RACH transmissions for acquisition of two TAs, according to an embodiment;

FIG. 8 is a diagram illustrating UE-initiated contention-free RACH transmissions for acquisition of a two TAs, according to an embodiment;

FIG. 9 is a diagram illustrating a TAC MAC CE, according to an embodiment;

FIG. 10 is a diagram illustrating M-TRP transmission across multiple slots with uplink overlapping due to a new TA command, according to an embodiment;

FIG. 11 is a diagram illustrating three PUSCHs with repetition type-B with two TA values to be cyclically applied, according to an embodiment;

FIG. 12 is a flowchart illustrating a method for acquiring and managing two TAs, according to an embodiment; and

FIG. 13 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

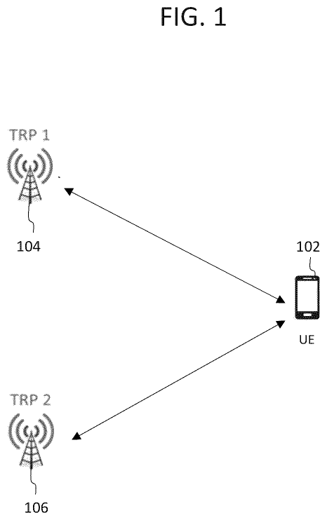

FIG. 1 is a diagram illustrating an M-TRP transmission scheme, according to an embodiment. A UE 102 is shown in communication with a first TRP 104 and a second TRP 106 within in a cell. Each of the first TRP 104 and the second TRP 106 has a respective TA valuc. Embodiments are provided herein for acquisition and maintenance of the two TAs values for M-TRP transmission.

According to an embodiment, a connection may first be established from initial access through a first TRP, and a corresponding first TA may be obtained through a UE-initiated RACH transmission. Subsequently, a network-initiated RACH transmission, in a connected mode, may be used to obtain a second TA corresponding to a second TRP. For intra-cell communication, a cross TRP RACH transmission mechanism may be used in which the first TRP transmits a PDCCH order to the UE, which triggers the RACH transmission associated with the second TRP. The PDCCH order may be sent via DCI format 1_0 with a cyclic redundancy check (CRC) scrambled using a cell-radio network temporary identifier (C-RNTI). The UE's C-RNTI may be dedicated to the first TRP. Accordingly, an association of the TRP and the PDCCH order, which differentiates RACH transmissions for different TRPs, may be indicated explicitly through a preamble grouping and an ra-PreambleIndex in the PDCCH order, or may be indicated implicitly through synchronization signal block (SSB) grouping and an SSB index in the PDCCH order. Such a resource grouping configuration may be provided by configuring multiple resource lists in RACH-ConfigCommon through SIB1 configurations. One example of such a configuration is when two prach-RootSequenceIndex and two ssb-perRACH-OccasionAndCB-PreamblesPerSSB are higher layer configured to the UE in the RACH-ConfigCommon. This may indicate the number of SSBs mapped per RACH occasion and the number of preambles available for SSB transmission for each TRP for CBRA, and/or two prach-ConfigurationIndex and two ssb-ResourceList may be higher layer configured to the UE in the RACH-ConfigDedicated for CFRA.

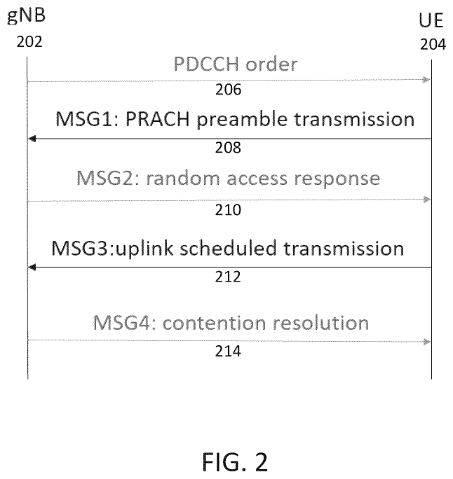

FIG. 2 is a diagram illustrating network-initiated contention-based RACH transmissions for acquisition of a second TA, according to an embodiment.

At 206, a gNB 202 may send a PDCCH order to a UE 204 via DCI format 1_0 with a CRC scrambled using a C-RNTI. The C-RNTI may be dedicated through an RRC connection to a first TRP. The PDCCH order may include an SSB index, ra-PreambleIndex, and PRACH mask index. At 208, the UE 204 may transmit a first message including a requested RA preamble corresponding to the second TRP with the corresponding identifier to the gNB 202. Upon receiving the preamble, the gNB 202 may send a second message including an RAR to the UE, at 210.

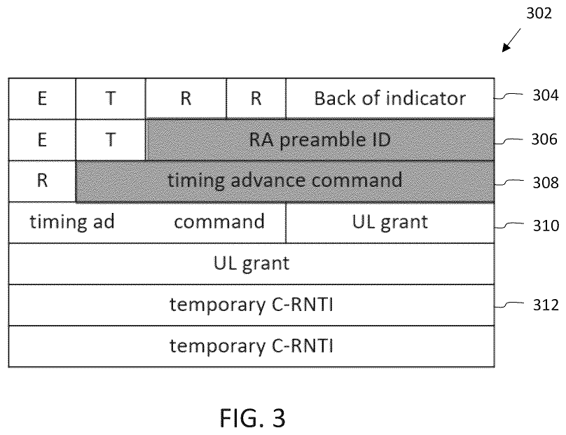

FIG. 3 is a diagram illustrating an RAR, according to an embodiment. An RAR 302 includes a backoff indicator 304, an RA preamble identifier 306, a TAC 308, an initial uplink grant 310, and a temporary C-RNTI 312.

Referring back to FIG. 2, if the UE 204 receives the RAR 210 containing an RA preamble identifier that is the same as the identifier contained in the transmitted RA preamble at 208, the response is successful and the UE 204 may transmit a third message including uplink scheduling information, including the UE's C-RNTI (e.g., by a Contention Resolution Identity), over a physical uplink shared channel (PUSCH), at 212. For contention resolution, at 214, the gNB 202 may transmit a fourth message including a contention resolution identity information element (IE), that is the same as that carried in the third message at 212, on the physical downlink shared channel (PDSCH).

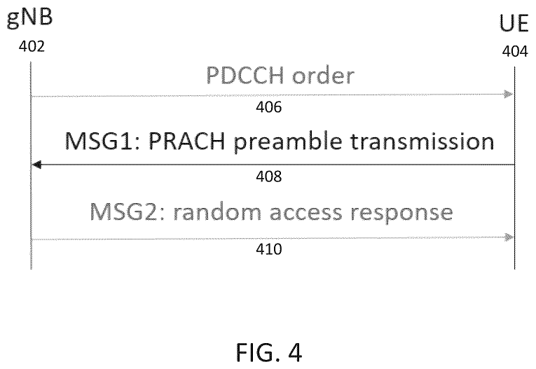

FIG. 4 is a diagram illustrating network-initiated contention-free RACH transmissions for acquisition of a second TA, according to an embodiment.

A dedicated RA preamble with a specific identifier may be provided to a UE 404 either via RRC signaling or a DCI that is explicitly for second TA acquisition. At 406, a gNB 402 sends a PDCCH order to the UE 404 via DCI format 1_0 with the CRC scrambled using the C-RNTI, as described above in FIG. 2. Steps 408 and 410 are similar to steps 208 and 210 described above with respect to FIG. 2. At 408, the UE 404 transmits a first message triggering the RACH procedure, and, at 410, the gNB 402 responds with a second message including the RAR and containing the second timing alignment information and the RA preamble identifier (i.e., ra-PreambleIndex).

For inter-cell M-TRP communication, a PRACH configuration associated with additional configured physical cell identifiers (PCIs), different from the PCI of the serving cell, may be supported. The additional PRACH configuration may be used in a RACH procedure triggered by a PDCCH order for the corresponding additional PCI. For inter-cell multiple-DCI (M-DCI)-based M-TRP communication, a PDCCH order sent by one TRP may trigger a RACH procedure towards either the same TRP or a different TRP.

A connection may be established from initial access from one TRP, and two TAs may be obtained through two UE-initiated RACH preamble transmissions, each corresponding to a different TRP. A first TA may be acquired from a first TRP during initial access, and another UE-initiated RACH transmission may be used to acquire a second TA from a second TRP.

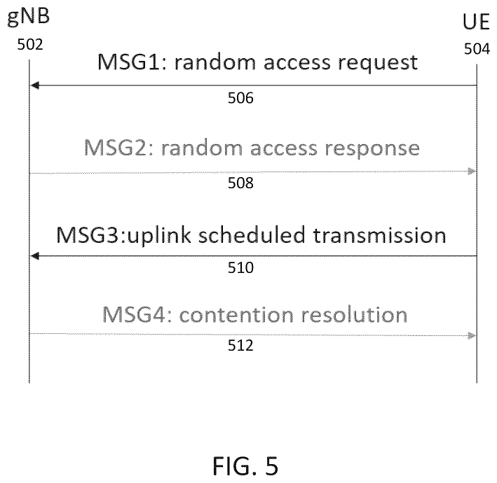

FIG. 5 is a diagram illustrating UE-initiated contention-based RACH transmissions for acquisition of a second TA, according to an embodiment. The UE may be assumed to already have a dedicated C-RNTI through an RRC connection to a first TRP when the UE initiates a second RACH transmission to a second TRP.

At 506, a UE 504 may transmit, to a gNB 502, a first message (e.g., random access request) including an RA preamble corresponding to the second TRP with an identifier. The association of TRPs and random access preambles may be explicitly indicated to the UE through preamble grouping, or may be implicitly indicated to the UE through SSB grouping provided by a configuration of multiple resource lists in RACH-ConfigCommon through SIB1 configurations.

Upon receiving the preamble, the gNB 502 sends a second message including an RAR over the PDSCH, to the UE 504, at 508. The RAR may include the RA-preamble identifier, timing alignment information, initial uplink grant, and a temporary C-RNTI. If the UE 504 receives an RAR including an RA preamble identifier that is the same as the identifier provided in the first message, the response is successful. The UE 504 transmits, at 510, a third message with uplink scheduling information, including at least the UE's C-RNTI (e.g. by a contention resolution identity), over the PUSCH, and/or a new message informing the gNB 502 that this is a second RA transmission for two TA acquisitions of an already RR-connected UE. After 510, a contention resolution timer may begin at the UE 504. At 512, the gNB 502 transmits, to the UE 504 via PDSCH, a fourth message including a contention resolution identity IE, which is the same as that carried in the third message at 510. If the contention resolution timer expires before the UE 504 receives the fourth message at 512, the UE 504 considers the contention resolution to have failed.

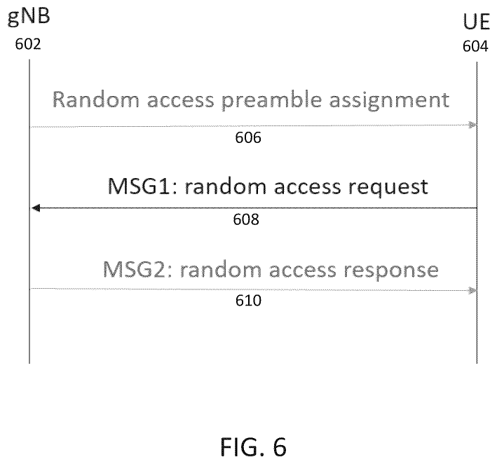

FIG. 6 is a diagram illustrating UE-initiated contention-free RACH transmissions for acquisition of a second TA, according to an embodiment.

For CFRA transmission, a dedicated RA preamble (with a specific identifier) is provided to a UE 604, from a gNB 602, either via RRC signaling or a DCI that is explicitly for a second UE-initiated RA transmission of two TA acquisitions by the UE 604. Therefore, there is no preamble conflict when the UE 604 transmits the first message (e.g. RA request) with a dedicated preamble and its identifier, at 608, and the second message (e.g., RAR) from the gNB 602, at 610, contains the timing alignment information and the RA preamble identifier.

A connection may also be established from initial access with two UE-initiated RACH preamble transmissions, each associated with one TRP, and obtaining two corresponding TAs. This scheme may be indicated to the UE through RACH-ConfigCommon configurations in SIB1 by configuring multiple resource lists (e.g., preamble or SSB lists) in RACH-ConfigCommon through SIB1 configurations.

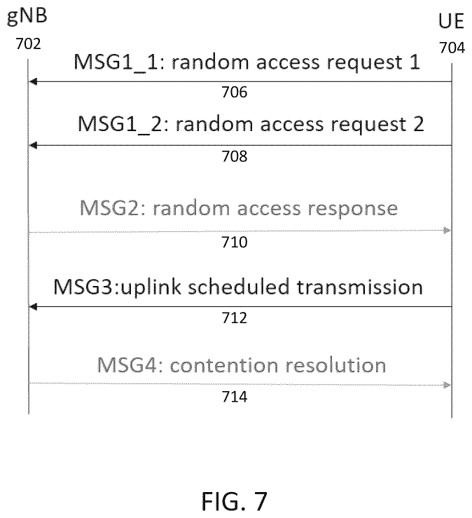

FIG. 7 is a diagram illustrating UE-initiated content-based RACH transmissions for acquisition of two TAs, according to an embodiment. The UE is assumed to not have any dedicated C-RNTI.

A UE 704 may transmit, to a gNB 702, a message (e.g., random access request 1) 706 and a message (e.g., random access request 2) 708. Each of the messages includes a preamble corresponding to a respective TRP, with a newly introduced identifier. This additional identifier is included to differentiate initial access of UEs with backward compatibility. Upon receiving a first additional identifier to a preamble ID at 706, the gNB 702 may start a timer for reception of a second preamble at 708. If the timer expires and the gNB 702 does not receive the second message at 708, the gNB 702 may fall back to a legacy initial access and may later transmit a PDCCH order to initiate a second RACH transmission for second TA acquisition.

Upon receiving both preambles at 706 and 708, the gNB 702 may send a second message (e.g., RAR) to the UE 704 over the PDSCH, at 710. The RAR may include two RA-preamble identifiers, two pieces of timing alignment information, an initial uplink grant, and a temporary C-RNTI. The UE 704 may receive the aforementioned information in a single RAR or in two separate RARs. When received in a single RAR, two RA-preamble identifiers, two pieces of timing alignment information, an initial uplink grant, and a temporary C-RNTI are included in the RAR that is transmitted from one of the TRPs. When received in two RARs, each RAR includes one RA-preamble identifier, one specific TA (corresponding to one of the TRPs), as well as a same temporary C-RNTI and initial uplink grant.

If the RAR/RARs include(s) an RA preamble identifier that is the same as the identifier provided at 706 and 708, the response is successful and the UE 704 may transmit a third message with uplink scheduling information over the PUSCH, at 712. At 714, the gNB 702 may transmit a message containing a contention resolution identity IE on the PDSCH that is the same as that provided in the third message at 712, for contention resolution.

Alternatively, the gNB may dedicate specific resources for UEs to differentiate initial access from legacy initial access. Multiple resource lists may be configured in RACH-ConfigCommon through SIB1 configurations. Upon receiving the first RA request message at 706, the gNB 702 may be aware that this RA-preamble identifier corresponds to a list and may expect a second preamble transmission from the UE.

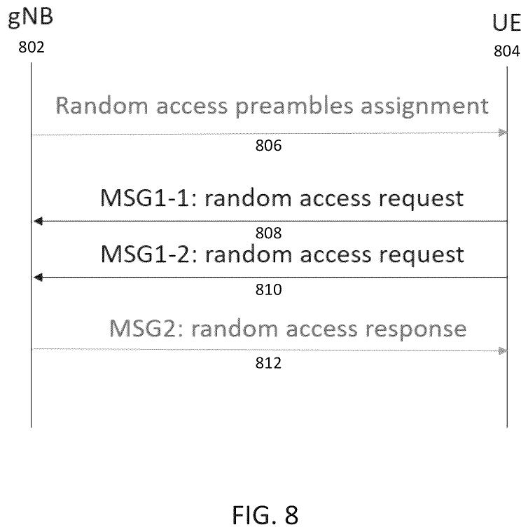

FIG. 8 is a diagram illustrating UE-initiated contention-free RACH transmissions for acquisition of two TAs, according to an embodiment.

At 806, two dedicated random access preambles with one RA-preamble identifier may be provided from a gNB 802, to a UE 804, either via RRC signaling or a DCI for UE-initiated RA transmissions for two TA acquisitions. Therefore, there is no preamble conflict and the UE 804 may transmit the dedicated preambles with a same identifier in messages having RA requests, at 808 and 810. A second message with an RAR from the gNB 802, at 808, may contain the two pieces of timing alignment information and the RA preamble identifier. The UE 804 may receive a single RAR or two separate RARs, as described above with respect to FIG. 7.

Due to UE mobility, a TA value should be measured and updated periodically to maintain uplink synchronization. The update of the TA value may be through a TAC for a specific TAG ID in a MAC CE.

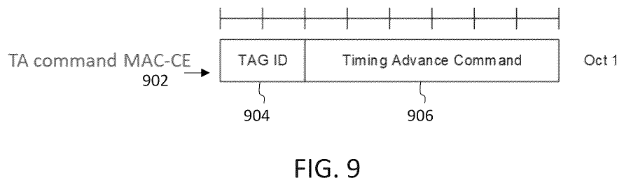

FIG. 9 is a diagram illustrating a TAC MAC CE, according to an embodiment. A TAG ID 904 and a TAC 906 are provided in a MAC CE 902. Accordingly, a TA may be maintained on a per TAG basis using the TAC MAC CE 902.

The configuration of two TAGs may be provided for each serving cell. Accordingly, a mechanism may be reused individually per TRP for its corresponding TA update. This can be performed individually for each TRP with one TAC and its corresponding TAG ID in the MAC CE, or alternatively, the MAC CE command may be enhanced to jointly include two TACs and corresponding TAG IDs at once.

Maintaining two TAs may require some enhancement on a UE-initiated RACH procedure in a connected mode. When a TA update for each TRP is performed individually with a specific TAG ID, and when timeAlignmentTimer of one specific TRP expires, the UE initiates RACH preamble transmissions toward a corresponding TRP. For the scheme where a TA update for both TRPs is performed jointly, the UE may initiate two RACH preamble transmissions simultaneously or individually, each associated with one TRP, and may obtain two corresponding TAs in one RAR or in two separate RARs.

In both above-described scenarios, however, differentiation of the RACH transmission toward different TRPs may be indicated to the UE explicitly (e.g., preamble grouping) or implicitly (e.g., SSB grouping) through SIB1 configurations such as RACH-ConfigCommon. Since the UE already has a dedicated C-RNTI, the RACH transmission mechanism may end after RAR receipt at the UE, where the UE only extracts the TA information. For inter-cell M-TRP communication, support of PRACH configuration associated with additional configured PCIs different from the PCI of the serving cell may be required.

With the configuration of two TAGs for each serving cell, the association of the configured TAGs with different TRPs may also be addressed. This may determine which one of the TAGs and corresponding TACs is applicable to channels and RSs of a specific TRP.

A TAG/TRP association may be explicitly indicated using semi-static configurations. Each channel and RS may have a specific RRC parameter configuration to indicate association to a specific TAG. The RRC parameter may use a vector bit or a bitmap structure to indicate the specific TAG to be applied for the channel and/or RS. For a M-TRP operation with two TRPs, a two-bit RRC parameter may be configured for each channel (PUCCH/PUSCH) and/or SRS. A configured value of ‘01’ may represent a first configured TAG or a TAG with a smallest TAG ID. A configured value of ‘10’ may represent a second configured TAG or a TAG with largest TAG ID. A configured value of ‘11’ (or ‘00’) may represent both configured TAGs to be applied for that channel and/or RS. Alternatively, another semi-static solution may be based on per TRP resource grouping and association of each TAG to one resource group. The UE may determine the TRP corresponding to a specific TAG based on SSB belonging to the associated resource group.

Alternatively, the UE may use a pre-determined rule to identify a TAG/TRP association such as an order of TAG IDs or an order of TAG RRC configurations. The TAGs may be mapped to repetition occasions according to the order of TAG IDs or according to the order of TAG RRC configurations for the serving cell. For a multi-DCI scheme, coresetPoolIndex may also be used as an implicit association of TAGs and TRPs. Each TAG may be associated with a coresetPoolIndex and the UE may determine the TRP corresponding to a specific TAG based on a particular coresetPoolIndex of scheduled channels and signals by the DCI.

A dynamic TAG/TRP association configuration may be supported where the association can be indicated, and may be provided to the UE in the scheduling/triggering DCI. New fields may be introduced or existing fields in DCI may be reused to indicate an associated TAG ID and corresponding TA for UL transmission through a vector bit format or bitmap format.

In TDM-based UL M-TRP transmission, two consecutive transmissions may overlap in a particular period of time. Such overlap already exists in TA updates in which a new TA is larger than an old TA, and hence, a first slot adopting the new TA is overlapped with a last slot adopting the old TA. The later slot may be shortened by not transmitting on the overlapped part of the later slot.

However, this may suffer from DMRS loss in case PUSCH mapping type-B is used for the later overlapping slot because the front-loaded DMRS would be lost as a result of duration reduction of that slot. To address this issue, the UE may not be expected to receive a TA command when the type-B PUSCH mapping is configured for the later overlapping slot, and such a scenario is considered an error case. The application of any new TA value, received while PUSCH mapping type-B is configured for a later overlapping slot, may wait until a next slot with non-front loaded DMRS and/or with PUSCH mapping type-A configuration. When two adjacent slots overlap due to a TA command with type-B PUSCH mapping configured for the later overlapping slot, the former slot may be reduced in duration relative to the later slot. The gNB may indicate the UE's behavior with configuration of a possible solution when an overlapping occurs. For example, an RRC configuration may inform a UE of which behavior to take between reducing the later UL transmission and/or the former UL transmission.

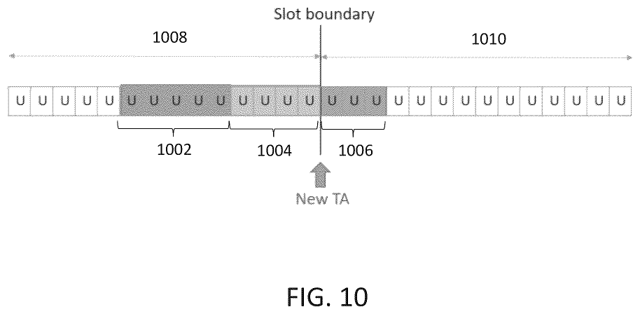

FIG. 10 is a diagram illustrating M-TRP transmission across multiple slots with uplink overlapping due to a new TA command, according to an embodiment. In single-DCI (S-DCI) PUSCH repetition B scheme (i.e., intra-slot repetition scheme), when first, second, and third repetition occasions 1002, 1004, and 1006 spread across multiple slots 1008 and 1010, two adjacent repetition occasions may overlap if the new TA is larger than the old TA.

The later repetition occasion may be shortened by not transmitting on the overlapped part of the later repetition occasion. Since S-DCI PUSCH repetition B scheme uses PUSCH mapping type-B, as described above, the solution may suffer from DMRS loss of the later repetition occasion. As an alternative, the UE may not expect to receive a TAC in the middle of an S-DCI PUSCH repetition B transmission, and if such a transmission occurs, it may be considered an error case. Alternatively, the application of any new TA value, received in the middle of the S-DCI PUSCH repetition B transmission, may wait until the end of all repetition occasions. As another alternative, when two adjacent repetition occasions of an S-DCI PUSCH repetition B transmission overlap due to a TA command, the former repetition occasion may be reduced in duration relative to the later repetition occasion. A more flexible solution is to let the gNB configuration indicate the UE's behavior. For example, an RRC configuration may indicate reducing the later repetition occasion and/or the former repetition occasion.

With enhancement on multiple TAs for UL M-TRP operation, the UE may be able to simultaneously transmit two different UL signals/channels in one component carrier (CC). The overlap may not only be across different slots but also within a given slot. The overlap may not only be occasional due to a new TAC but also frequent due to the fact that different UL signals/channels are associated with different TAs.

If the UE can support simultaneous multiple UL transmissions (e.g., with two UL beams or different Tx chains/PAs or any other implementation), UL overlapping may not be an issue and no scheduling restriction may be needed. An UL overlapping issue for UEs not supporting simultaneous multiple UL transmissions is described below.

The UL overlapping issue for an S-DCI-based M-TRP transmission, may be prevented by network implementation since the gNB may have knowledge and may be able to calculate the length of the overlapping region. The gNB may adopt different DL reference timings to pre-compensate for the overlapping time duration and prevent overlapped UL transmissions due to multiple TAs enhancement at the UE side. However, as described above, a new TA command may cause adjacent slots and/or repetition occasions to overlap in the S-DCI based M-TRP transmission if the new TA is larger than the old TA and hence, solutions described above are also applicable to S-DCI-based UL M-TRP operations.

For M-DCI-based M-TRP transmissions, with two TRPs adopting independent DL reference timings, the gNB may not be able to calculate the length of the overlapped part. It cannot always be assumed that both TRPs have knowledge of the overlapping region between transmissions corresponding to the two TAs, and this doesn't prevent the network from applying scheduling restrictions even with no knowledge of the overlapping region. Scheduling constraints in the time domain may be introduced to avoid the overlap. Solutions described above for two overlapping UL transmissions due to a new TA are also applicable to M-DCI based UL M-TRP operations.

For inter-slot overlapping, where two UL transmissions are associated with two different TAs (due to multiple TAs enhancement) in two consecutive slots, the latter slot may be reduced in duration relative to the former slot. However, this solution may suffer from DMRS loss when PUSCH mapping type-B is used for the latter overlapping slot. Additionally, the UL overlapping due to multiple TAs enhancement, despite a new TA overlapping, is not a one-time event and may be carried over to all UL transmissions. To address these aspects, the former slot may always be reduced in duration relative to the later slot under such overlapping scenario or in general as a unified solution for any overlapping adjacent UL slots. A more flexible solution is for the gNB configuration to indicate the UE's behavior. For example, an RRC configuration may indicate reducing the later UL slot and/or the former UL slot. As an alternative, such a scenario may be considered an error case, and gNB implementation may allocate/schedule M-TRP UL transmission occasions in an order to prevent such overlapping due to multiple TAs enhancement. For example, the UL for the TRP with a larger TA value is scheduled first followed by the TRP with a smaller TA valuc. However, such a solution may not be feasible at the gNB due to the fact that the two TRPs may adopt independent DL reference timings. Alternatively, a scheduling restriction may be applied in which a time gap greater than or equal to the largest TA is considered in between each two consecutive M-TRP UL transmission occasions. For example, the gNB may partition a slot with gap considerations for M-TRP UL transmissions in order to prevent any possible overlapping. A combination of scheduling restriction and a dropping rule may also be applied, in which an unsuccessful attempt of a gNB scheduling restriction to prevent UL overlapping is addressed by reducing the later UL transmission and/or the former UL transmission, or alternatively by gNB configuration of a possible solution to UE.

For intra-slot overlapping in which two adjacent UL transmissions are associated with two different TAs (due to multiple TAs enhancement), the later UL transmission may be reduced in duration relative to the former UL transmission. However, this solution may suffer from DMRS loss when PUSCH mapping type-B is used for the latter overlapping transmission. As an alternative, the former UL transmission may be reduced in duration relative to the later UL transmission only under such a scenario or in general as a unified solution for any overlapping adjacent UL transmissions. However, neither solution may be practical as the dropping may be carried over to all UL transmissions in the overlapping events due to multiple TAs enhancements (e.g., for the type-B repetition scheme). One solution is to consider such a scenario an error case, and gNB scheduling and implementation may be required to prevent such a scenario. A more flexible solution is to let a gNB configuration indicate a UE's behavior. For example, an RRC configuration may indicate reducing the later UL transmission and/or the former UL transmission. Alternatively, a scheduling restriction may be applied where a time gap greater than or equal to the largest TA is always applied in between each two consecutive M-TRP UL transmissions. A scheduling restriction may be applied where the gNB partitions a slot with gap consideration for M-TRP UL transmissions in order to prevent any possible overlapping. These schemes may change the definition of a type-B repetition scheme as back-to-back UL repetition occasions towards multiple TRPs. Alternatively, a scheduling restriction may be applied where the gNB cannot schedule intra-slot M-DCI-based M-TRP UL transmissions with multiple TA enhancement. A combination of scheduling restriction and a dropping rule may also be applied, where an unsuccessful attempt of a gNB scheduling restriction to prevent UL overlapping may be addressed by reducing the later UL transmission and/or the former UL transmission, or alternatively, by a gNB configuration of a possible solution to the UE.

A nominal PUSCH repetition may be divided into multiple actual repetitions when the nominal repetition collides with invalid symbols or crosses the slot boundary. Several rules may be provided to determine such invalid symbols. This framework may be further extended when the UE is supposed to apply two or more TAs for any reason.

When the gNB configures/schedules the UE to transmit PUSCH with repetition type-B, and the UE is provided with (or determines) two or more TAs to be applied for different repetitions, the UE may determine the invalid symbol(s) using any combination of following.

The number of invalid symbol(s) may be determined based on the time that the UE needs to switch among different TA values. The UE may provide the gNB with the needed duration via capability signaling. The duration may be in units of msec, usec, symbols, or the like. If the UE uses msec or usec to indicate the duration, it may be translated into a number of symbols based on a subcarrier spacing (SCS) of the scheduled/configured PUSCH with repetition type-B (e.g., # of symbols=Ceil (the indicated duration/durations of symbol based on SCS of PUSCH)). If the UE uses symbols to indicate the duration, it may be based on a reference SCS that may be predefined. When applied, it may be converted to an actual number of symbols based on SCS of the scheduled/configured PUSCH with repetition type-B. For example, if the UE indicates one symbol based on a reference SCS of 15 KHz, but the scheduled/configured PUSCH with repetition type-B is with a SCS of 30 KHz, then the invalid duration is two symbols. Alternatively, the duration may be predefined for different SCSs. The applicable duration may be determined based on the SCS of the scheduled/configured PUSCH with repetition type-B, as described herein.

Other rules and methods may be applied to determine the number of invalid symbols to enable the UE adjust its TA and prevent overlapping between PUSCH with repetition type-B.

The invalid symbols may be determined between any two consecutive nominal repetition based on: (1) the invalid symbol(s) is applied to former nominal repetition among any two consecutive nominal PUSCH repetitions; (2) the invalid symbol(s) is applied to latter nominal repetition among any two consecutive nominal PUSCH repetitions; and/or (3) the invalid symbol(s) is applied to both nominal repetitions among any two consecutive nominal PUSCH repetitions.

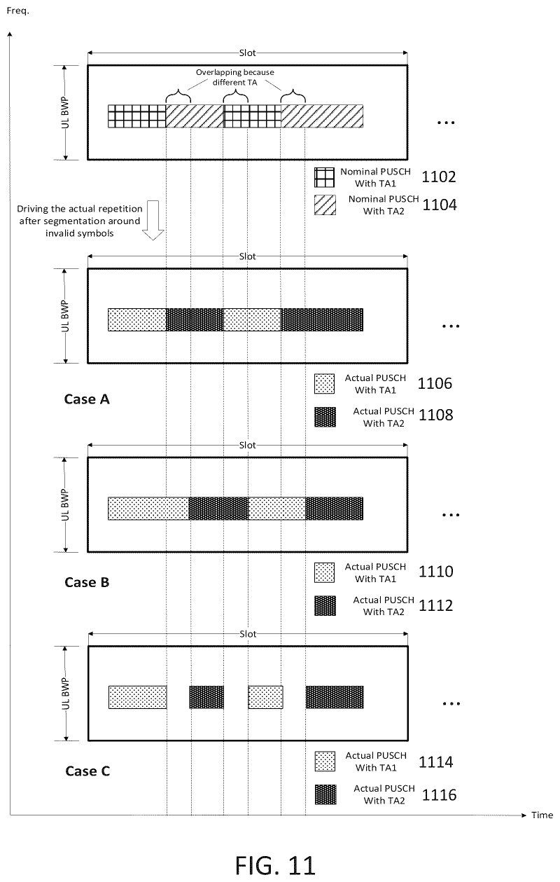

FIG. 11 is a diagram illustrating three PUSCHs with repetition type-B with two TA values to be cyclically applied, according to an embodiment. Specifically, a nominal PUSCH with a first TA 1102 is shown to overlap a nominal PUSCH with a second TA 1104. In Case A, invalid symbols are counted from the former nominal PUSCH repetition (i.e., earlier in the time domain) among two consecutive nominal PUSCH repetitions, and a resulting PUSCH with the first TA 1106 and a resulting PUSCH with the second TA 1108 are shown. In Case B, invalid symbol(s) are counted from the latter nominal PUSCH repetition (i.e., latter in the time domain) among two consecutive nominal PUSCH repetitions, and a resulting PUSCH with the first TA 1110 and a resulting PUSCH with the second TA 1112 are shown. In Case C, invalid symbol(s) are counted from both nominal PUSCH repetitions among two consecutive nominal PUSCH repetitions, and a resulting PUSCH with the first TA 1114 and a resulting PUSCH with the second TA 1116 are shown.

Alternatively, a solution for handling the case of multiple TAs applied to consecutive UL transmissions, may be applied per actual PUSCH repetition when PUSCH is configured/scheduled with type-B repetitions.

Although embodiments described herein are for a case in which UL transmissions are directed to different TRPs, they may also be applied if UL transmissions are directed to the same TRP, but two or more TAs should be applied. This may be beneficial in a full duplex operation in which the UE may apply different TAs depending on whether the UL transmission falls in symbols used for full duplex operation or non-full duplex operation. The TA values associated with different TRPs may be replaced with TA values associated with full duplex operation or non-full duplex operation.

UE capability signaling refers to a mechanism with which the UE informs the gNB of its capability to perform certain features. For example, the UE may report its capability to perform certain features in any scenario. In this case, the UE reports its capability on a per-UE basis. The UE may report its capability to perform certain features in particular bands. In this case, the UE reports its capability on a per-band basis. The UE may report its capability to perform certain features in particular band combinations for CA. In this case, the UE reports its capability on a per-band combination or per-BC basis. The UE may report its capability to perform certain features in specific band(s) in particular band combination for carrier aggregation (CA). In this case, a mechanism referred to as feature sets (FS) may be used to allow for such flexibility in reporting, and the UE reports its capability on a per-featureSet or per-FS basis. The UE may report its capability to perform certain features in specific CCs in a particular band combination for CA. In this case, a mechanism referred to as feature sets per CC may be used to allow for such flexibility in reporting, and the UE reports its capability on a per-featureSet per cc or per-FSPC basis.

A band combination is a collection of bands to represent a CA configuration. A UE's flexibility for declaring support of certain features increases in the list above. For example, if feature A and feature B are per-FSPC, a UE may have full flexibility of supporting only one of feature A and B in each CC. However, if those features are per-UE, then a UE would always need to support or not support. A trade-off to added flexibility is its overhead in signaling. Therefore, a determination of how a certain feature is declared must acknowledge the complexity of the feature in UE implementation and associated signaling overhead.

Regarding the overlapping issue with two TA enhancement for M-TRP UL transmission, as described above, a scheduling gap or restriction should be considered. Assuming a capability is created for UL transmission overlapping, such capability may be considered a pre-requisite for two TA transmissions that address the overlapping concern, and thus, no such scheduling handling would be necessary. The scheduling gap or restriction rule may only be applicable for UEs that do not support UL transmission overlapping.

Another approach is not to consider UL transmission overlapping capability as a pre-requisite for two TA transmissions. Under such scenarios, the UE may declare UL transmission overlapping capability but it would have difficulty supporting overlapping M-TRP UL transmissions with two TAs. To address this, an option may be provided for a UE to be able not to support these two capabilities simultaneously. This may be done if both capabilities are configured in either FS or FSPC manner. However, these capabilities granularity would not be FS or FSPC, and an extra capability would need to be created to address a joint operations.

For the gNB to be able to partition a slot as a scheduling gap restriction to address overlapping concern for M-TRP UL transmissions with two TAs, support of mapping type-B is mandatory for UL transmission in current specification. However, when a UE has difficulty to support mapping type-B with two TAs for M-TRP UL transmissions, an option may be provided for a UE to be able not to simultaneously support UL transmission with mapping type-B and two TAs. Thus, a new capability may be created regarding such joint operations.

UE features 40-2-1 and 40-2-2 are basic features for multi-DCI based intra-cell multi-TRP operation with two TA enhancement as shown below in Table 1 and Table 2, where signaling granularity is still FFS.

TABLE 1

| | | | | | | | | | | | |
|---|---|---|---|---|---|---|---|---|---|---|---|
| 40. | 40-2-1 | Basic feature | Support of multi- | 16- | yes | n/a | [Per | n/a | n/a | n/a | Optional |
| NR_MIMO_evo_ | | for multi- | DCI based intra- | 2a | | | band] | | | | with |
| DL_UL | | DCI based | cell Multi-TRP | | | | | | | | capability |
| | | intra-cell | operation with | | | | | | | | signaling |
| | | Multi-TRP | two TA | | | | | | | | |
| | | operation | enhancement | | | | | | | | |
| | | with two TA | FFS: what to | | | | | | | | |
| | | enhancement | do/signal when | | | | | | | | |
| | | | UE also supports | | | | | | | | |
| | | | multi-DCI based | | | | | | | | |
| | | | STxMP | | | | | | | | |
| | | | PUSCH + PUSCH | | | | | | | | |
| | | | FFS: what to | | | | | | | | |
| | | | do/signal about | | | | | | | | |
| | | | absolute TA | | | | | | | | |
| | | | command MAC | | | | | | | | |
| | | | CE | | | | | | | | |
| | | | FFS: Maximum | | | | | | | | |
| | | | number of n- | | | | | | | | |
| | | | TimingAdvance | | | | | | | | |
| | | | Offset value per | | | | | | | | |
| | | | serving cell | | | | | | | | |

TABLE 2

| | | | | | | | | | | | |
|---|---|---|---|---|---|---|---|---|---|---|---|
| 40. | 40-2-2 | Basic feature | Support of multi- | 16- | yes | n/a | [Per | n/a | n/a | n/a | Optional |
| NR_MIMO_evo_ | | for multi- | DCI based inter- | 2a | | | band] | | | | with |
| DL_UL | | DCI based | cell Multi-TRP | | | | | | | | capability |
| | | inter-cell | operation with | | | | | | | | signaling |
| | | Multi-TRP | two TA | | | | | | | | |
| | | operation | enhancement | | | | | | | | |
| | | with two TA | FFS: what to | | | | | | | | |
| | | enhancement | do/signal when | | | | | | | | |
| | | | UE also supports | | | | | | | | |
| | | | multi-DCI based | | | | | | | | |
| | | | STxMP | | | | | | | | |
| | | | PUSCH + PUSCH | | | | | | | | |
| | | | FFS: what to | | | | | | | | |
| | | | do/signal about | | | | | | | | |
| | | | absolute TA | | | | | | | | |
| | | | command MAC | | | | | | | | |
| | | | CE | | | | | | | | |
| | | | FFS: Maximum | | | | | | | | |
| | | | number of n- | | | | | | | | |
| | | | TimingAdvance | | | | | | | | |
| | | | Offset value per | | | | | | | | |
| | | | serving cell | | | | | | | | |

Support of feature 40-2-1 and/or 40-2-2 may require a significant UE complexity increase in terms of control logics and baseband processing. To facilitate an alternative, less complex UE implementations for support of this basic feature, the signaling granularity of 40-2-1 and 40-2-2 should be per band combination (BC), per FS, or per band and per BC. The proposed granularity of ‘per band AND per BC’ is not a well-defined signaling mechanism in 3GPP UE capability signaling. This signaling granularity can be realized through interworking of two separate UE capability signaling of ‘per band’ as well as ‘per BC’. Since ‘per band’ signaling would indicate that the UE can perform FG 40-2-1 and FG 40-2-2 in particular bands while ‘per BC’ signaling would indicate that the UE can perform FG 40-2-1 and FG 40-2-2 in particular band combinations for CA, a ‘per band AND per BC’ signaling indicates that a UE can perform FG 40-2-1 and FG 40-2-2 in particular bands in accordance to its ‘per band’ signaling inside each indicated band combination belonging to its ‘per BC’ signaling. An example of such is when ‘per band’ signaling indicates {{b₁, b₂, b₃} for FG 40-2-1 and FG 40-2-2 and ‘per BC’ signaling indicates {b₁+b₂, b₁+b₂+b₄, b₂+b₃} for FG 40-2-1 and FG 40-2-2, then ‘per band AND per BC’ signaling granularity would indicate that a UE supports FG 40-2-1 and FG 40-2-2 in all bands in BC1 (i.e., in b₁, b₂ bands in b₁+b₂), in all bands except b₄ in BC2 (i.e., in b₁, b₂ bands in b₁+b₂+b₄), and in all bands in BC3 (i.e., in b₂, b₃ bands in b₂+b₃). A further advance interworking alternative for ‘per band AND per BC’ signaling is that when the ‘per BC’ signaling further indicates maximum number of CC. An example of such is when ‘per band’ signaling indicates {b₁, b₂, b₃, b₄, b₅} and ‘per BC’ signaling indicates {b₁+b₂+b₃+b₄+b₅} for FG 40-2-1 and FG 40-2-2, then all bands can only be simultaneously supported if the UE signals #CC=5. That is even though all bands of b₁, b₂, b₃, b₄ and by have been indicated in ‘per band’ signaling, if the #CC=2, gNB can pick any two combinations of five bands in this BC {b₁+b₂+b₃+b₄+b₅}.

For an M-DCI-based M-TRP operation with two TA enhancement, for the case when the UE does not support UL STxMP transmission, the UE may not expect the two UL transmissions to overlap (i.e., scheduling restriction is applied to avoid overlap between the two UL transmissions). As an optional feature, an overlapping duration of the later of the two UL transmissions may be reduced. The overlapping duration may be specified as two OFDM symbols when the UE is capable of supporting MRTD>CP, SCS=60 kHz and frequency range is FR1. The overlapping duration may be specified as one OFDM symbol in all other cases.

Two capability levels may be considered for UL transmission overlapping with two TAs.

As a first capability level, a UE may not expect any overlapping of two UL transmissions in an M-DCI-based M-TRP operation with two TA enhancement, since the network would avoid any overlap between the two UL transmissions through scheduling restriction. If such overlap occurs as an error case, the UE may drop the later transmission.

As a second capability level, a UE may handle a specific overlap duration for two UL transmissions in M-DCI based M-TRP operation with two TA enhancement. The UE may expect that two UL transmissions overlap with a specific duration, and if it occurs, the overlapping duration of the later of the two UL transmissions may be reduced. The signaling granularity of such UE capabilities may be FS or FSPC, following the DL counterpart design.

TABLE 3

| | | | | | | | | | | | |
|---|---|---|---|---|---|---|---|---|---|---|---|
| 40. | 40-2-7 | UL | Support of | 40-2-1 or | yes | n/a | Per | n/a | n/a | n/a | Optional |
| NR_MIMO_evo_ | | overlapping | UL | 40-2-2 | | | FS | | | | with |
| DL_UL | | in multi-DCI | overlapping | | | | | | | | capability |
| | | based Multi- | by reducing | | | | | | | | signaling |
| | | TRP | the latter UL | | | | | | | | |
| | | operation | transmission | | | | | | | | |
| | | with two TA | in multi-DCI | | | | | | | | |
| | | enhancement | based Multi- | | | | | | | | |
| | | | TRP | | | | | | | | |
| | | | operation | | | | | | | | |
| | | | with two TA | | | | | | | | |
| | | | enhancement | | | | | | | | |

A UE may additionally support simultaneous multiple UL transmissions via FG 40-2-6 (with pre-requisite of FG 40-2-1 and/or FG 40-2-2), can be assumed that can well handle any overlap duration with no reduction of any of UL transmissions for two UL transmissions in multi-DCI based M-TRP operation with two TA enhancement, as shown in Table 4 below.

TABLE 4

| | | | | | | | | | | | | |
|---|---|---|---|---|---|---|---|---|---|---|---|---|
| 40. | 40-2-6 | Two TAs | Support of | 40-2-1 or | yes | n/a | Per | n/a | n/a | n/a | Note: | Optional |
| NR_MIMO_evo_ | | for multi- | two TAs | 40-2-2 | | | FS | | | | Support of | with |
| DL_UL | | DCI | for multi- | | | | | | | | any overlap | capability |
| | | STxMP | DCI | | | | | | | | duration with | signaling |
| | | PUSCH + | STxMP | | | | | | | | no reduction | |
| | | PUSCH | PUSCH + | | | | | | | | of any of UL | |
| | | | PUSCH | | | | | | | | transmissions | |
| | | | | | | | | | | | for two UL | |
| | | | | | | | | | | | transmissions | |
| | | | | | | | | | | | in multi- | |
| | | | | | | | | | | | DCI based | |
| | | | | | | | | | | | Multi-TRP | |
| | | | | | | | | | | | with 2 TA | |

Another alternative is that UL STxMP and overlapping UL transmissions with 2TAs can be independent capabilities, each configured in FS or FSPC manner. As such, a separate new UE capability can be introduced for joint operation of UL overlapping transmissions with 2TAs and UL STxMP transmission having pre-requisite of both 40-2-6 as well as FG 40-2-7, as below.

The signaling granularity of such UE capability can be FS or FSPC, following the DL counterpart design.

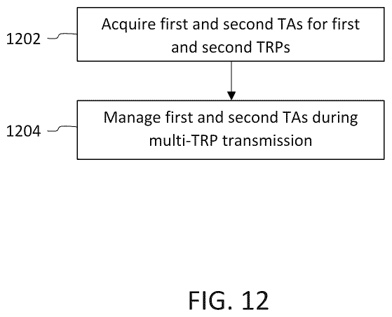

FIG. 12 is a flowchart illustrating a method for acquiring and managing two TAs, according to an embodiment. At 1202, a UE acquires a first TA value for a first TRP and a second TA value for a second TRP, from a BS, via RACH signaling. The first TA value may be acquired via UE-initiated contention-based or contention-free RACH transmissions. The second TA value may be acquired via UE-initiated or network-initiated contention-based or contention-free RACH transmissions. Alternatively, both the first TA value and the second TA value may be simultaneously acquired via UE-initiated contention-based or contention-free RACH transmissions.

At 1204, the UE manages the first TA value and the second TA value during M-TRP transmission with a cell having the first TRP and the second TRP. One or more MAC CEs including TACs may be received, and TA values may be updated based on the TACs. The MAC CEs may include TACs and TAG identifiers. A TAG identifier may correspond to a TRP. The TAC may be received in a slot configured for non-front-loaded DMRS or a PUSCH mapping type-A configuration, or the TA may be updated in the slot configured for non-front-loaded DMRS or the PUSCH mapping type-A configuration.

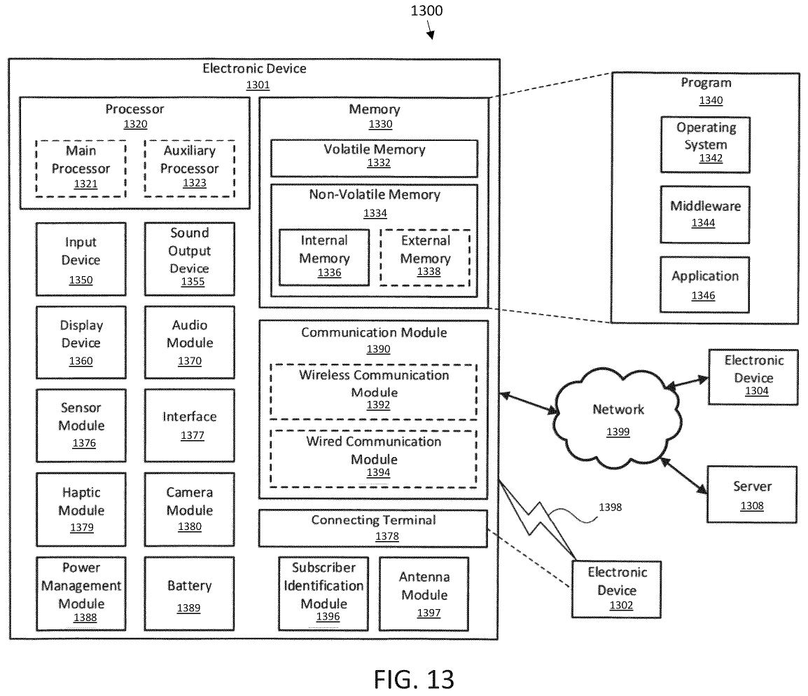

FIG. 13 is a block diagram of an electronic device in a network environment 1300, according to an embodiment.

Referring to FIG. 13, an electronic device 1301 in a network environment 1300 may communicate with an electronic device 1302 via a first network 1398 (e.g., a short-range wireless communication network), or an electronic device 1304 or a server 1308 via a second network 1399 (e.g., a long-range wireless communication network). The electronic device 1301 may communicate with the electronic device 1304 via the server 1308. The electronic device 1301 may include a processor 1320, a memory 1330, an input device 1350, a sound output device 1355, a display device 1360, an audio module 1370, a sensor module 1376, an interface 1377, a haptic module 1379, a camera module 1380, a power management module 1388, a battery 1389, a communication module 1390, a subscriber identification module (SIM) card 1396, or an antenna module 1397. In one embodiment, at least one (e.g., the display device 1360 or the camera module 1380) of the components may be omitted from the electronic device 1301, or one or more other components may be added to the electronic device 1301. Some of the components may be implemented as a single integrated circuit (IC). For example, the sensor module 1376 (e.g., a fingerprint sensor, an iris sensor, or an illuminance sensor) may be embedded in the display device 1360 (e.g., a display).

The processor 1320 may execute software (e.g., a program 1340) to control at least one other component (e.g., a hardware or a software component) of the electronic device 1301 coupled with the processor 1320 and may perform various data processing or computations.

As at least part of the data processing or computations, the processor 1320 may load a command or data received from another component (e.g., the sensor module 1376 or the communication module 1390) in volatile memory 1332, process the command or the data stored in the volatile memory 1332, and store resulting data in non-volatile memory 1334. The processor 1320 may include a main processor 1321 (e.g., a central processing unit (CPU) or an application processor (AP)), and an auxiliary processor 1323 (e.g., a graphics processing unit (GPU), an image signal processor (ISP), a sensor hub processor, or a communication processor (CP)) that is operable independently from, or in conjunction with, the main processor 1321. Additionally or alternatively, the auxiliary processor 1323 may be adapted to consume less power than the main processor 1321, or execute a particular function. The auxiliary processor 1323 may be implemented as being separate from, or a part of, the main processor 1321.

The auxiliary processor 1323 may control at least some of the functions or states related to at least one component (e.g., the display device 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). The auxiliary processor 1323 (e.g., an image signal processor or a communication processor) may be implemented as part of another component (e.g., the camera module 1380 or the communication module 1390) functionally related to the auxiliary processor 1323.

The memory 1330 may store various data used by at least one component (e.g., the processor 1320 or the sensor module 1376) of the electronic device 1301. The various data may include, for example, software (e.g., the program 1340) and input data or output data for a command related thereto. The memory 1330 may include the volatile memory 1332 or the non-volatile memory 1334. Non-volatile memory 1334 may include internal memory 1336 and/or external memory 1338.

The program 1340 may be stored in the memory 1330 as software, and may include, for example, an operating system (OS) 1342, middleware 1344, or an application 1346.

The input device 1350 may receive a command or data to be used by another component (e.g., the processor 1320) of the electronic device 1301, from the outside (e.g., a user) of the electronic device 1301. The input device 1350 may include, for example, a microphone, a mouse, or a keyboard.

The sound output device 1355 may output sound signals to the outside of the electronic device 1301. The sound output device 1355 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1360 may visually provide information to the outside (e.g., a user) of the electronic device 1301. The display device 1360 may include, for example, a display, a hologram device, or a projector and control circuitry to control a corresponding one of the display, hologram device, and projector. The display device 1360 may include touch circuitry adapted to detect a touch, or sensor circuitry (e.g., a pressure sensor) adapted to measure the intensity of force incurred by the touch.

The audio module 1370 may convert a sound into an electrical signal and vice versa. The audio module 1370 may obtain the sound via the input device 1350 or output the sound via the sound output device 1355 or a headphone of an external electronic device 1302 directly (e.g., wired) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. The sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device 1302 directly (e.g., wired) or wirelessly. The interface 1377 may include, for example, a high-definition multimedia interface (HDMI), a universal serial bus (USB) interface, a secure digital (SD) card interface, or an audio interface.

A connecting terminal 1378 may include a connector via which the electronic device 1301 may be physically connected with the external electronic device 1302. The connecting terminal 1378 may include, for example, an HDMI connector, a USB connector, an SD card connector, or an audio connector (e.g., a headphone connector).

The haptic module 1379 may convert an electrical signal into a mechanical stimulus (e.g., a vibration or a movement) or an electrical stimulus which may be recognized by a user via tactile sensation or kinesthetic sensation. The haptic module 1379 may include, for example, a motor, a piezoelectric element, or an electrical stimulator.

The camera module 1380 may capture a still image or moving images. The camera module 1380 may include one or more lenses, image sensors, image signal processors, or flashes. The power management module 1388 may manage power supplied to the electronic device 1301. The power management module 1388 may be implemented as at least part of, for example, a power management integrated circuit (PMIC).

The battery 1389 may supply power to at least one component of the electronic device 1301. The battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the AP) and supports a direct (e.g., wired) communication or a wireless communication. The communication module 1390 may include a wireless communication module 1392 (e.g., a cellular communication module, a short-range wireless communication module, or a global navigation satellite system (GNSS) communication module) or a wired communication module 1394 (e.g., a local arca network (LAN) communication module or a power line communication (PLC) module). A corresponding one of these communication modules may communicate with the external electronic device via the first network 1398 (e.g., a short-range communication network, such as BLUETOOTH™, wireless-fidelity (Wi-Fi) direct, or a standard of the Infrared Data Association (IrDA)) or the second network 1399 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The antenna module 1397 may transmit or receive a signal or power to or from the outside (e.g., the external electronic device) of the electronic device 1301. The antenna module 1397 may include one or more antennas, and, therefrom, at least one antenna appropriate for a communication scheme used in the communication network, such as the first network 1398 or the second network 1399, may be selected, for example, by the communication module 1390 (e.g., the wireless communication module 1392). The signal or the power may then be transmitted or received between the communication module 1390 and the external electronic device via the selected at least one antenna.

Commands or data may be transmitted or received between the electronic device 1301 and the external electronic device 1304 via the server 1308 coupled with the second network 1399. Each of the electronic devices 1302 and 1304 may be a device of a same type as, or a different type, from the electronic device 1301. All or some of operations to be executed at the electronic device 1301 may be executed at one or more of the external electronic devices 1302, 1304, or 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1301. The electronic device 1301 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
acquiring, by a user equipment (UE), from a base station (BS), a first timing advance (TA) value for a first transmission and reception point (TRP) and a second TA value for a second TRP via random access channel (RACH) signaling based on an identifier; and
managing, by the UE, the first TA value and the second TA value during multi-TRP transmission within a cell having the first TRP and the second TRP.

2. The method of claim 1, wherein acquiring the first TA value and the second TA value comprises:
transmitting, by the UE, to the BS, a first RACH preamble corresponding to the first TRP; and
receiving, by the UE, from the BS, a first random access response (RAR) indicating the first TA value and a first RACH preamble identifier.

3. The method of claim 2, wherein acquiring the first TA value and the second TA value further comprises:
transmitting, by the UE, to the BS, a second RACH preamble corresponding to the second TRP; and
receiving, by the UE, from the BS, a second RAR comprising the second TA value and a second RACH preamble identifier.

4. The method of claim 3, wherein acquiring the first TA value and the second TA value further comprises:
receiving, by the UE, a physical downlink control channel (PDCCH) order from the BS, wherein transmission of the second RACH preamble is based on reception of the PDCCH order.

5. The method of claim 1, wherein acquiring the first TA value and the second TA value comprises:
transmitting, by the UE, to the BS, a third RACH preamble corresponding to the first TRP;
transmitting, by the UE, to the BS, a fourth RACH preamble corresponding to the second TRP; and
receiving, by the UE, from the BS, one or more RARs comprising the first and second TA values and third and fourth RACH preamble identifiers.

6. The method of claim 5, wherein the one or more RARs comprise:
a third RAR comprising the first and second TA values and the third and fourth RACH preamble identifiers; or
a fourth RAR comprising the first TA value and the third RACH preamble identifier, and a fifth RAR comprising the second TA value and the fourth RACH preamble identifier.

7. The method of claim 1, wherein managing the first TA value and the second TA value comprises:
receiving, by the UE, from the BS, one or more medium access control (MAC) control elements (CEs) comprising a first TA command (TAC) and a second TAC; and
updating, by the UE, the first TA value based on the first TAC, and the second TA value based on the second TAC.

8. The method of claim 7, wherein receiving the one or more MAC CEs comprises:
receiving, at the UE, from the BS, a first MAC CE and a second MAC CE, the first MAC CE comprising the first TAC and a first TA group (TAG) identifier corresponding to the first TAC, and the second MAC CE comprising the second TAC and a second TAG identifier corresponding to the second TAC; or
receiving, at the UE, from the BS, a third MAC CE comprising the first TAC, the first TAG identifier, the second TAC, and the second TAG identifier.

9. The method of claim 8, wherein the first TAG identifier corresponds to the first TRP and the second TAG identifier corresponds to the second TRP.

10. The method of claim 1, wherein managing the first TA value and the second TA value comprises:
updating the first TA value or the second TA value based on a TAC;
wherein the TAC is received in a slot configured for a non-front-loaded demodulation reference signal (DMRS) or a physical uplink shared channel (PUSCH) mapping type-A configuration; or
wherein the first TA value or the second TA value is updated in the slot configured for the non-front-loaded DMRS or the PUSCH mapping type-A configuration.

11. A method comprising:
providing, to a user equipment (UE), from a base station (BS), a first timing advance (TA) value for a first transmission and reception point (TRP) and a second TA value for a second TRP via random access channel (RACH) signaling based on an identifier; and
managing, by the BS, the first TA value and the second TA value at the UE during multi-TRP transmission within a cell having the first TRP and the second TRP.

12. The method of claim 11, wherein providing the first TA value and the second TA value comprises:
receiving, from the UE, by the BS, a first RACH preamble corresponding to the first TRP; and
transmitting, to the UE, from the BS, a first random access response (RAR) indicating the first TA value and a first RACH preamble identifier.

13. The method of claim 12, wherein providing the first TA value and the second TA value further comprises:
receiving, from the UE, by the BS, a second RACH preamble corresponding to the second TRP; and
transmitting, to the UE, from the BS, a second RAR comprising the second TA value and a second RACH preamble identifier.

14. The method of claim 13, wherein providing the first TA value and the second TA value further comprises:
transmitting, to the UE, by the BS, a physical downlink control channel (PDCCH) order, wherein transmission of the second RACH preamble is based on reception of the PDCCH order at the UE.

15. The method of claim 11, wherein providing the first TA value and the second TA value comprises:
receiving, from the UE, by the BS, a third RACH preamble corresponding to the first TRP;
receiving, from the UE, by the BS, a fourth RACH preamble corresponding to the second TRP; and
transmitting, to the UE, from the BS, one or more RARs comprising the first and second TA values and third and fourth RACH preamble identifiers.

16. The method of claim 15, wherein the one or more RARs comprise:
a third RAR comprising the first and second TA values and the third and fourth RACH preamble identifiers; or
a fourth RAR comprising the first TA value and the third RACH preamble identifier, and a fifth RAR comprising the second TA value and the fourth RACH preamble identifier.

17. The method of claim 11, wherein managing the first TA value and the second TA value comprises:
transmitting, to the UE, from the BS, one or more medium access control (MAC) control elements (CEs) comprising a first TA command (TAC) and a second TAC,
wherein the UE updates the first TA value based on the first TAC, and the second TA value based on the second TAC.

18. The method of claim 17, wherein transmitting the one or more MAC CEs comprises:
transmitting, to the UE, from the BS, a first MAC CE and a second MAC CE, the first MAC CE comprising the first TAC and a first TA group (TAG) identifier corresponding to the first TAC, and the second MAC CE comprising the second TAC and a second TAG identifier corresponding to the second TAC; or
transmitting, to the UE, from the BS, a third MAC CE comprising the first TAC, the first TAG identifier, the second TAC, and the second TAG identifier,
wherein the first TAG identifier corresponds to the first TRP and the second TAG identifier corresponds to the second TRP.

19. The method of claim 11, wherein managing the first TA value and the second TA value comprises:
transmitting a TAC from the BS to the UE, wherein the UE updates the first TA value or the second TA value based on a TAC,
wherein the TAC is transmitted in a slot configured for a non-front-loaded demodulation reference signal (DMRS) or a physical uplink shared channel (PUSCH) mapping type-A configuration; or
wherein the first TA value or the second TA value is updated in the slot configured for the non-front-loaded DMRS or the PUSCH mapping type-A configuration.

20. A user equipment (UE) comprising:
a processor; and
a non-transitory computer readable storage medium storing instructions that, when executed, cause the processor to:
acquire, from a base station (BS), a first timing advance (TA) value for a first transmission and reception point (TRP) and a second TA value for a second TRP via random access channel (RACH) signaling based on an identifier; and
manage the first TA value and the second TA value during multi-TRP transmission within a cell having the first TRP and the second TRP.
